(19) United States
(12) Patent Application Publication
(10) Pub. No.: US 2006/0125644 A1
(43) Pub. Date: Jun. 15, 2006

(54) Tracking method and apparatus

(76) Inventor: Ian Sharp, New South Wales (AU)

Correspondence Address: LADAS & PARRY LLP, 224 SOUTH MICHIGAN AVENUE, SUITE 1600, CHICAGO, IL, 60604, US

(21) Appl. No.: 10/547,238

(22) PCT Filed: Feb. 25, 2004
(86) PCT No.: PCT/AU04/00239

§ 371 Date: Jan. 23, 2006

(51) Int. Cl. G08B 23/00

(52) U.S. Cl. 340/573.1

(57) ABSTRACT

A method of tracking a human or animal is disclosed. A mobile unit is carried by the human or animal, the mobile unit including at least one inertial sensor and a radio transmitter for transmitting data from the mobile unit to a base station. The output data of the inertial sensor is used to count the number of steps taken by the human or animal, and the position of the human or animal is predicted based on the number of steps taken and step length data for the human or animal.

### FIELD OF THE INVENTION

The present invention relates to a method and apparatus for tracking a human or animal.

### BACKGROUND TO THE INVENTION

Radiolocation systems such as GPS are well known, but although the systems typically have good long-term accuracy, their short-term accuracy can be poor, particularly in a cluttered multi-path environment. The incorporation of inertial sensors has been applied to improve the performance of radiolocation systems used for navigation of aircraft, ships, submarines, and more recently, vehicles such as cars and trucks. Accelerometer data can be integrated to acquire velocity data, and a second integration results in displacement. Similarly, the integration of rate-gyro data results in angular or heading data. With three-axis sensors, motion in three dimensions can be tracked. One important characteristic of such position data is the good short-term accuracy, although small errors in the sensor data mean the long-term accuracy is poor. Thus, by combining the radiolocation and sensor data, which have complementary performance, the overall accuracy is improved.

The present invention concerns the tracking of people or animals. There are a number of applications, both indoor and outdoor for such a tracking system. The preferred application of the proposed method is indoors where the radiolocation performance is poor or non-existent; for example GPS does not function inside buildings. Potential applications include the office environment, hospital/nursing homes, high security environments where traceability of people is crucial, and fire fighting in buildings. Outdoor applications in which the invention may be advantageously employed are situations where wide-area navigation systems, such as GPS, are not available. A potential area of applications in sports. Applications in the sports area are varied and include tracking of racehorses on a track or athletes on a track or a sports field. A variant of the sports application is in the training activities associated with these sports, where the main aim is to obtain biomedical data associated with fitness. In this case, the positional data could be combined with medical sensor data to provide additional information not currently available from existing technology. In all of these applications, the position data can be used to generate animated displays based on the data.

However, there are a number of problems associated with tracking people or animals which are not present in relation to other systems designed to track aircraft, ships, or cars. Firstly, there are problems with indoor environments in which such a system might be used, in that radiolocation is made inaccurate by errors caused by multiple signal paths.

Also, any inertial sensors included in a mobile unit, such as a mobile telephone, must be very small, as the unit must be small and lightweight to enable it to be easily carried by a person or animal. The small size of the sensors restricts their performance, and therefore their accuracy will be much worse than sensors used in traditional inertial navigation systems. Because of the poor accuracy of the sensors, integration time is restricted to comparatively short periods, say a maximum of seconds for a positional accuracy of a few metres.

Furthermore, the unit cannot be firmly attached to the body, so that the orientation of the sensors is not accurately known. Indeed, the orientation can vary with each use of the system, so that the system must be recalibrated on each use. The device may be carried in different ways by different people, for instance, men typically wear the device on a belt or in a coat pocket, whereas women typically carry the device in a bag. Sensors used typically have poor stability in the bias offset, so that some form of real time compensation if necessary if the integrated sensor output are to be of any practical use. Furthermore, the motion of the human body is much more complex than rigid bodies such as aircraft, so that the sensor outputs are typically dominated by the accelerations and rotations associated with activities such as walking, rather than accelerations associated with changing positions.

In summary, because of the differences in the sensors and the operating environment, the application of traditional methods for the integration of inertial and sensor data is inappropriate for tracking humans or animals.

### SUMMARY OF THE INVENTION

According to the present invention, a method of tracking a human or animal comprises:

providing a mobile unit to be carried by the human or animal, the mobile unit including at least one inertial sensor and a radio transmitter for transmitting data from the mobile unit to a base station;

using the output data of the inertial sensor to count the number of steps taken by the human or animal; and

predicting the position of the human or animal based on the number of steps taken and step length data for the human or animal.

In this method, the number of steps taken by the human or animal can be determined from the data of the inertial sensor, such as an accelerometer or rate-gyro. If the human or animal is following a known path, such as an athlete or a racehorse on a track, orientation data are not necessarily required to predict the position of the human or animal. However, the mobile unit preferably includes a sensor for detecting the direction of movement. Two magnetometers can be used to measure the earth's magnetic field in two orthogonal directions, and by combining these data an estimate of the heading angle can be determined. Additionally, a rate-gyro may be used to detect rotations of the person or animal. As indoors the earth's magnetic field can suffer from magnetic anomalies, these two types of sensors can advantageously be used in combination to increase the accuracy of the heading angle determination. In particular, the rate-gyro data can preferably be used to filter out anomalies in the magnetometer data.

Because the long-term accuracy of the method employing inertial sensors alone can be poor, preferably the method includes periodically correcting the position data by comparison to a reference point (checkpoint). This function may be achieved by periodically monitoring the position by a radiolocation system such as GPS. Alternatively or additionally, a map-matching technique may be used, wherein the predicted position is located on a map, such as a map of a building, and corrected accordingly. The map matching requires the identification of particular checking points on the map of the building which may be based on distinctive behaviour of a person or animal. This distinctive behaviour may be detectable by the inertial sensors. Examples of distinctive behaviour could include 90 degrees turns (very common in buildings), and walking up/down stairs (which has a pattern distinctive form walking). When such an event is detected, the dead-reckoning position is compared with the checkpoint's position, and if the error is sufficiently small (say 5 metres), the position of the mobile is corrected to that of the checkpoint. A further possibility may be to periodically check the position by reference to a further system, for instance, in a building, a security system whereby a key or card is required to pass through doors.

To obtain a reasonably accurate displacement estimate from the counting of steps, the average stride length must be known. The stride length of the user could be measured and entered as a parameter, but preferably the system automatically determines this parameter. The average stride length can be determined if the number of footsteps between two known positions is measured The known positions can be based on an accurate radiolocation and/or by the map-matching technique. Preferably, this stride length parameter is regularly updated.

In one preferred embodiment, the system is applied to sports training, and the mobile unit additionally includes at least one bio-sensor for obtaining biomedical data associated with fitness. Examples include a heart rate monitor or a breathing rate monitor. The position and inertial sensor data can be combined to derive parameters such as stride length and rate, speed, lap times, and this can be matched with the biosensor data such as heart rate and breathing rate. In effect, the positional/inertial data are the “input”, and the biosensors measure the “output”. Combining these two sets of data provides good information regarding physical fitness. The system allows real-time interaction between a coach and an athlete, so that performance tasks can be adapted as required by the coach based on real-time observation of performance. A radio can also be used for bio-feedback to the athlete, and audio prompts can be used to guide the athlete in a given task.

The method may include generating an animated display indicating the position of the human or animal on a map. The map may be of a building or sports track or field.

### BRIEF DESCRIPTION OF THE DRAWINGS

Preferred embodiments of the present invention will now be described with reference to the accompanying drawings, in which:

FIG. 1 shows the measured accelerometer data on 3-axes for a person walking;

FIG. 2 shows the measured compass heading data, and the effect of correction using the rate-gyro data;

FIG. 3 shows a measured path; and

FIG. 4 is a graph showing the range from the mobile unit to the base station for the example of FIG. 3.

### DETAILED DESCRIPTION OF THE EXAMPLES

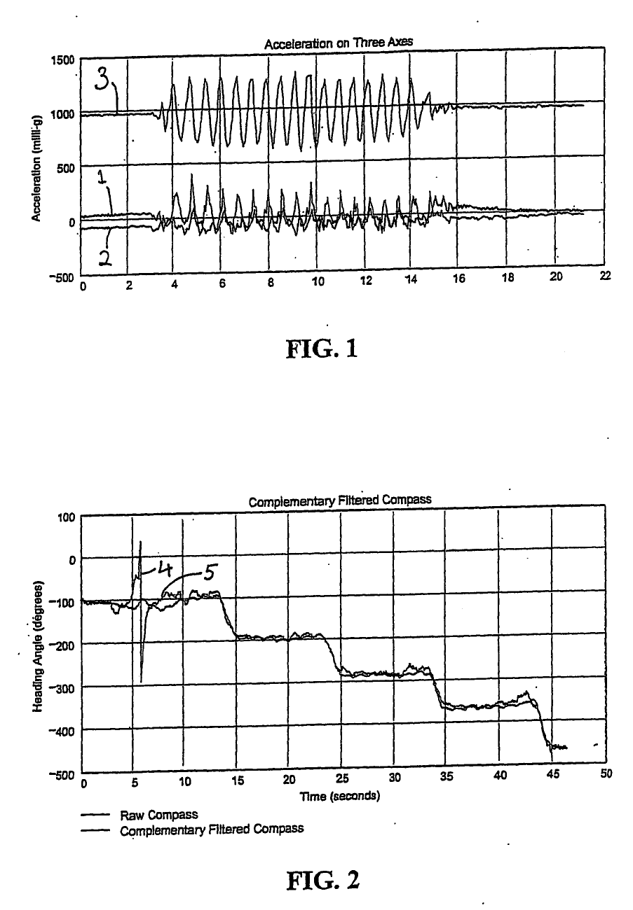

The preferred embodiment relates to indoor position location, and particularly position location inside a building. The basis of the indoor operation using the inertial data is to estimate the track by counting the number of steps and by measuring the direction of travel using the compass (as corrected by the rate-gyro data). The number of steps can be determined from the accelerometer data. FIG. 1 shows an example of the accelerometer data on the x-axis 1, the y-axis 2, and the z-axis 3, for a person walling, and it can clearly be seen that each individual step can be detected on all three axes, although the steps are more clearly evident on the z axis accelerometer. Further, the data also can be used to detect when the person is stationary, so that both movement and stationary states can be deduced.

As shown in FIG. 2, the second type of sensor data that is used is the compass or heading angle. Two magnetometers are used to measure the earth's magnetic field in two orthogonal directions, and by combining these data an estimate of the heading angle is determined The magnetometer data 4 are shown in FIG. 2, and it can be seen that there are anomalies in the magnetometer data 4. This behaviour is because, indoors the earth's magnetic field can suffer from magnetic anomalies, which typically result in local variations in the computed heading angle when moving around a building. These short-term variations can be minimised by the application of a complementary filter, which utilises the short-term stability of the rate-gyro and the long-term stability of the compass to obtain better accuracy in the heading data. FIG. 2 shows the filtered data 5, in which the anomalies have been largely removed.

By combining the displacement inferred from counting the number of steps and the heading data, an estimate of the position as a function of time can be determined. Note that these positional data are relative to the initial starting point, but if this point is known (using radiolocation or some other technique), then the positions can be determined absolutely. This technique is referred to as “dead-reckoning”.

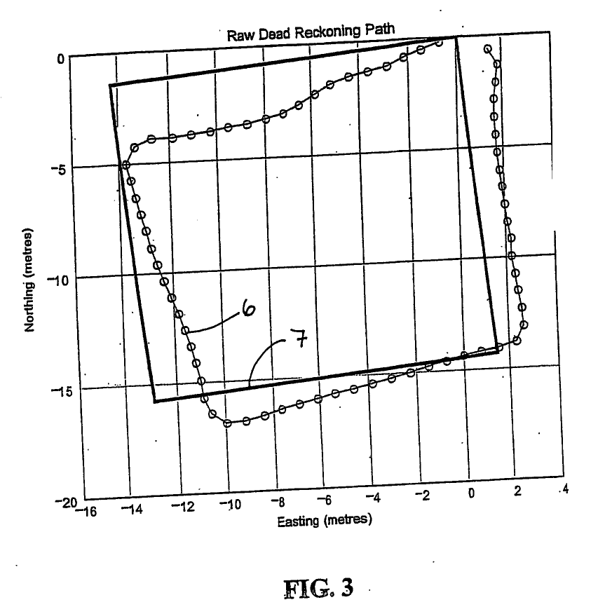

To obtain a reasonably accurate displacement estimate from the counting of footsteps, the average stride length must be known While the stride length of individuals (user of the mobile unit) could be independently measured and entered as a parameter, a better approach is for the system to automatically determine this parameter. The average stride length can be determined if the number of footsteps between two known positions is measured. The known positions can be based on an accurate radiolocation or by the map matching technique described further below. Thus the “true” displacement and the number of footsteps can be combined to determine the average stride length. This stride length estimate can then be used for further dead-reckoning until another known point is reached. The accuracy of the position fix is related to the variation in the stride length and the heading accuracy. If, for example, the average stride length of 1 metre has an accuracy of 5 percent, a typical stride rate of one per second results in a positional error of ±3 metres after one minute of walking. If the dead reckoning is corrected every minute, then the positional error can be capped to ±3 metres for all time. This indoor accuracy compares favourably with (say) GPS outdoors. FIG. 3 shows an example of the raw integrated 6 from the data shown in the accelerometer and compass data of FIGS. 1 and 2, and the actual path 7. The circles are the individual footsteps.

An important element of the indoor position location system is the regular updating of the dead-reckoning position at “known” positions or checkpoints. One approach is to use radiolocation; for example when the person is close to a Base Station the position can be determined to within a few metres using either timing range data and/or signal strength data. The range can be determined by measuring the elapsed delay for around-trip from the Base Station to the mobile and back to the Base Station. By accounting for the delay in the equipment, the two-way propagation delay can be converted to a range using the know speed of propagation of radio waves.

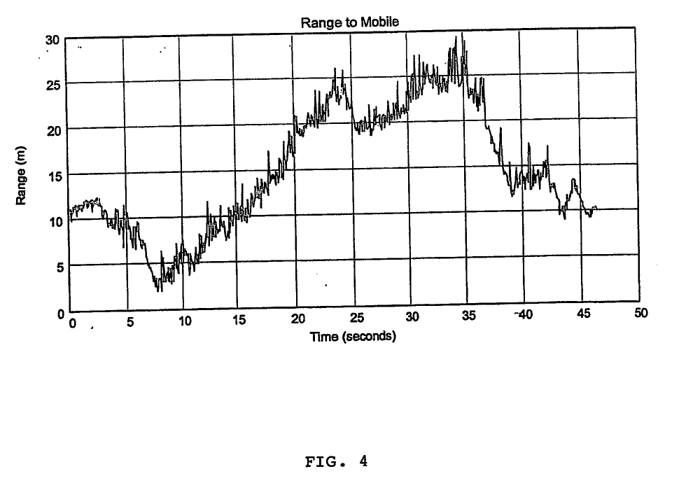

This is illustrated in FIG. 4, which shows the range to the mobile unit from the Base Station for the example given previously. The track passes close (2 metres) to the Base Station at a time of about 8 seconds, so that the position is known to within 2 metres at this time. Thus the position can be updated using the Base Station location as the checkpoint. The noise in the measured range limits the accuracy indoors to a few metres. If the range to two such Base Stations is measured, the position can be determined. However, the accuracy depends on the range, and decreases as the range increases. Typical accuracy at 40 metres range inside a office building is of the order of 10 metres.

However, for a practical implementation the number of Base Stations will be limited. A more accurate method of position determination is “map matching”. From a map of a building the checkpoints are extracted for the map matching task The checkpoints may include 90 and 180 degree turns, stairs, restrictions points such as doorways, building entry at security points requiring a card or other security device, and common positions of rest (such as a desk in an office, or a chair or bed in a home). Some checkpoints could additionally be associated with measuring the range to a Base Station. If a map of the building is used in conjunction with the dead-reckoning, positions can be inferred from the map and the motion of the mobile/person. For example, if the position is known initially, this position can be located on the building map. As the person walks through the building, the position can be plotted on the map. However, the position cannot be arbitrary, as the path must not (for example) go through wall. At certain points, the path will pass through restriction point such as a doorway. Provided the dead-reckoning position at this time is accurate to (say) ±3 metres, the doorway can be located without error on the map, and thus the position at that point in time is accurately known. This procedure can be used to regularly correct the position, thus preventing the errors from increasing over time without limit.

The location system can be further enhanced as the system measures activity and direction as well as position. For example, the posture of the person can be determined from the accelerometer data, so that the difference between standing still, walking, sitting and lying down can be determined. These activities can be further used to assess the position of the person. For example, if the person is seated in a direction associated with working on a computer in a known room, then it can be reasonably assumed that the person is in fact at the location of the computer/desk/chair. This technique can be used to match activities/locations for a particular person, thus providing a profile of the activities of the person, as well as the position/track of the person. This type of system can be used for a variety of applications, including monitoring of people in hazardous locations, or (say) elderly people in their home. Any unusual activity could be used to sound an alarm. Statistical data on activity is also a useful measure of heath, so that medical applications for the technology can be envisioned.

The preferred embodiment of the proposed system relates to indoor position location applications, where the resources of radiolocation, sensor data and other relevant information can be combined to obtain positional data. However, the method can be extended to outdoor applications, and in particular the integration of the radiolocation and sensor data can be performed using the traditional techniques. For example, a GPS unit could provide the radiolocation data outside (and corrected using the sensor data), while an alternative radiolocation system would be used indoors. Thus the combined system could provide seamless operation both outdoors and indoors.

It is to be understood that a reference herein to a prior art publication does not constitute an admission that the publication forms a part of the common general knowledge in the art in Australia, or any other country.

In the claims which follow and in the preceding summary of the invention, except where the context requires otherwise due to express language or necessary implication, the word “comprising” is used in the sense of “including”, i.e. the features specified may be associated with further features in various embodiments of the invention.

1. A method of tracking a human or animal comprising:
providing a mobile unit to be carried by the human or animal, the mobile unit including at least one inertial sensor generating inertial data and a radio transmitter for transmitting the inertial data from the mobile unit to a base station;
using the inertial data at the base station to count the number of steps taken by the human or animal; and
predicting the position of the human or animal based on the number of steps taken and step length data for the human or animal.

2. A method of tracking a human or animal according to claim 1, wherein the mobile unit includes a sensor for detecting the direction of movement.

3. A method of tracking a human or animal according to claim 2, wherein the sensor for detecting the direction of movement comprises two magnetometers which measure the earth's magnetic field in two orthogonal directions.

4. A method of tracking a human or animal according to claim 3, wherein the unit includes a rate-gyro, and wherein the method includes the step of filtering the magnetometer data by using the rate-gyro in a complementary fashion to filter out anomalies in the magnetometer data.

5. A method of tracking a human or animal according to claim 4, comprising the step of periodically correcting the position data at known positions.

6. A method of tracking a human or animal according to claim 5, wherein the step of correcting the position data comprises periodically monitoring the position by a radiolocation system.

7. A method of tracking a human or animal according to claim 6, wherein the step of correcting the position data includes locating the predicted position on a map, and correcting the position data accordingly.

8. A method of tracking a human or animal according to claim 7, wherein the method includes the step of determining the step length based on the number of steps taken between two known positions.

9. A system for tracking a human or animal comprising:
a mobile unit to be carried by the human or animal, the mobile unit including at least one inertial sensor generating inertial data and a radio transmitter for transmitting the inertial data from the mobile unit; and
a base station for receiving data from the mobile unit, the base station comprising:
means for counting, from the inertial data, the number of steps taken by the human or animal; and
means for predicting the position of the human or animal based on the number of steps taken and step length data for the human or animal.

10. A system for tracking a human or animal according to claim 9, wherein the mobile unit includes a sensor for detecting the direction of movement.

11. A system for tracking a human or animal according to claim 10, wherein the sensor for detecting the direction of movement comprises two magnetometers which measure the earth's magnetic field in two orthogonal directions.

12. A system for tracking a human or animal according to claim 11, wherein the mobile unit includes a rate-gyro, and wherein the system includes means for filtering the magnetometer data using the rate-gyro in a complementary fashion to filter out anomalies in the magnetometer data.

13. A mobile unit to be carried by a human or animal for tracking the human or animal comprising:
at least one inertial sensor and a transmitter for transmitting data from the mobile unit to a base station.

14. A mobile unit according to claim 13, including a sensor for detecting the direction of movement of the human or animal.

15. A mobile unit according to claim 14, wherein the sensor for detecting the direction of movement comprises two magnetometers which measure the earth's magnetic field in two orthogonal directions.

16. A mobile unit according to claim 15, further including a rate-gyro.

17. A mobile unit according to claim 16, further including a means of measuring the arrival time of a signal from the base station, and adjusting the local clock to synchronise with the base station's clock, but delayed by the combined effect of the propagation delay and delays in the base station transmitter and the mobile receiver.

18. A mobile unit according to claim 16, further including a transmitter synchronised to the local mobile clock.

19. A base station for tracking a human or animal comprising:
a receiver for receiving output data of an inertial sensor from a mobile unit carried by the human or animal;
means for counting, from the inertial data, the number of steps taken by the human or animal; and
means for predicting the position of the human or animal based on the number of steps taken and step length data for the human or animal.

20. A base station according to claim 19, wherein the receiver receives output data of magnetometers and a rate-gyro from the mobile unit, including means for deriving a filter from the rate-gyro data, and means for filtering the magnetometer data to filter out anomalies in the magnetometer data, to thereby derive the direction of movement of the human or animal.

21. A base station according to claim 20, further including means for determining the arrival time of the signal from the mobile unit, and means for determining distance of the mobile unit knowing the measured round-trip delay and the delays in the base station and mobile equipment.
